(19) United States
(12) Patent Application Publication
(10) Pub. No.: US 2009/0077641 A1
(43) Pub. Date: Mar. 19, 2009

(54) COLLABORATIVE PROCESSING USING INFERENCE LOGIC

(76) Inventor: Nicholas Mark Trevallyn-Jones, New South Wales (AU)

Correspondence Address: KNOBBE MARTENS OLSON & BEAR LLP, 2040 MAIN STREET, FOURTEENTH FLOOR, IRVINE, CA, 92614, US

(21) Appl. No.: 11/577,673

(22) PCT Filed: Oct. 24, 2005
(86) PCT No.: PCT/AU05/01647

§ 371 Date: Apr. 20, 2007

(30) Foreign Application Priority Data
Oct. 22, 2004 (AU) 2004906110

(51) Int. Cl. H04L 9/32; G06N 5/04; G06N 5/02

(52) U.S. Cl. 726/6; 706/46; 726/7; 706/47

(57) ABSTRACT

A collaborative engine electronically processes a request for a result using inference logic. If insufficient goals are provided to resolve the request, a partial result is generated as a function of one or more unresolvable goals. The request for a result may be processed with two or more collaborative engines using workspace chaining, to process information from/to multiple domains or systems which have security restrictions preventing full flow of information between them. Inputs available to the workspace of one collaborative engine are resolved as far as possible and a partial result based on that processing is generated and transmitted for further processing in the workspace of another collaborative engine. The invention may be used for determining a routing path for data or telephonic communication to/from a user of a communication network, or for processing of a management action for a component of an electronic data network, or a commercial transaction.

### TECHNICAL FIELD OF THE INVENTION

This invention relates to a method and apparatus for electronically processing a request for a result using inference logic. In a particular embodiment, it is directed to a method and apparatus for cooperatively processing, using computer-based inference logic, inputs from a plurality of parties, wherein the private inputs of each party are not disclosed to other parties.

### BACKGROUND OF THE INVENTION

A glossary of some of the terms used herein is provided at the end of this specification. The examples and explanations included in the glossary are provided for clarification or explanatory purposes, and are not intended to be limiting.

Businesses are increasingly using inference logic to automate processes, because the declarative nature of inference rules means they can readily define business rules, and inference rules can be quickly modified to reflect changing business requirements. In a simplified view, inferencing is the process by which new facts are derived from known facts by the application of inference rules in a workspace. In this context, ‘facts’ represent a known value for an entity (eg “CUSTOMER=Company-A”, where ‘Company-A’ could be a simple value or the current state of a complex structure) and ‘rules’ represent the relationship between facts and are typically in the form “if A then B” (eg “if CUSTOMER=Company-A then DISCOUNT=10%”).

More generally, inference logic derives results by resolving inference goals, which are typically facts and rules but can also include other constructs (eg constraints) in a workspace. A ‘workspace’ is the area of memory in which inference goals are resolved for a given computation. The inference logic determines the goal to resolve next as a function of initial input and goals already resolved, and produces a result when all the goals required for that result have been resolved. This means that if one or more required goals cannot be resolved, no result is produced. Inference logic retrieves goals from a knowledge base which typically comprises one or more data stores, but other implementations are possible. Inference logic may be implemented as dedicated logic, often referred to as an inference engine, or may be included as part of a larger piece of logic, such as an application program. Adrian A. Hopgood in Intelligent Systems for Engineers and Scientists (CRC Press, 2000, 2^{nd} Edn) provides an introduction to inference logic and practical applications of knowledge-based systems (as well as other intelligent systems).

Communication networks, such as the Internet, are increasingly used by cooperating parties for the exchange of information and for collaborative undertakings and processes. Automating such collaborative processes often calls for cooperative computation where the computation task is based on the inputs of more than one party.

Traditional imperative programming can be used to implement automated collaborative processing. Imperative programming describes a computation in terms of a program state, and statements that change the program state. Imperative programs (eg programs written in languages such as COBOL, C, C++, Java etc.) are a sequence of commands for the computer to perform. Recipes are a familiar analogy; each step is an instruction and the physical world holds the state. With imperative programming, the logic controlling the computation is embedded in the code of the individual systems.

A major drawback of such systems arises because the program logic includes much or all of the business rules. This means the program logic must be re-evaluated, altered and re-tested whenever the business rules change to the extent that they require a change in how processing occurs. Keeping a system in line with the business rules requires some vision into the future, because changing the system to match new business rules may take months, or even years, depending on the system code and how difficult it is to implement changes.

Because imperative programming is based on state, input and output are in terms of values, normally expressed as parameters (name, value pairs). Implementing a bespoke automated collaborative processing solution using imperative programming requires communication between systems to be in terms of parameters. The parameters must be defined so that they have the same meaning in the different systems, and they must be transported between systems and mapped between systems.

Such systems are “tightly-coupled”, in that each system has a very precise expectation of how the other systems to which it is connected will behave. This means parties that wish to automate collaborative processes must typically cooperate in the design, purchase and implementation of their systems to ensure they are compatible. When one party wishes to collaborate with a number of other parties, it must either specify, purchase and install a number of different systems, or reach an agreement with the other parties on a single standard system. Such tightly-coupled systems are also very sensitive to change. Often, if one party upgrades its system, the upgraded system will no longer be compatible with some or all of the other systems. Organising simultaneous upgrades for a number of parties can be extremely difficult, or even impossible. In a practical sense, these solutions are only viable for a small number of cooperating parties and are usually only used by larger organisations connecting to a few of their long-term partners.

One way to simplify the communication process is to use a standardised format for describing transactions, for example, Electronic Data Interchange (EDI). EDI provides a communication scheme for business-to-business transactions between trading partners. The standard prescribes the formats, character sets and data elements used in the exchange of business documents and forms, such as purchase orders, shipping documents and invoices. The standard states which pieces of information are mandatory for a particular document, and which pieces are optional, and gives rules for the structure of the document Trading partners still have to agree on the specific information to be transmitted and how it should be used and this requires a detailed procedural and technical agreement between the partners. Typical EDI deployments require 6 to 18 months to jointly design, agree and implement the transaction definitions that will be used between just two companies. Whilst EDI helps partners to communicate in a standardised, automated way, transactions are defined in very inflexible terms, and computerised negotiation is not supported.

Inference logic is an obvious alternative to imperative programming for implementing automated collaborative processing. Using inference logic has the advantage that the business rules are not embedded in the program logic. New business rules can be much more easily, quickly and reliably incorporated than can changes to systems implemented with imperative programming.

In addition, inference rules are inherently very flexible, and therefore they are well suited to describing business transactions. There still needs to be agreement on the fundamental terms used to describe a transaction, but each party can use rules to define how these agreed terms relate to that party. In addition, because rules express relationships, and not just values as in imperative programming, they can express negotiable terms and computerised negotiation is possible.

There are proposals for cooperative processing using inference logic. In the context of electronic commerce, for instance, electronic markets (auctions) are seen as an application which could be automated using inference logic. For example, Benjamin N. Grosof, Daniel Reeves and Michael P. Wellman, in an article entitled “Automated Negotiation and Declarative Contract Descriptions” in Proceedings of the Fifth International Conference on Automated Agents, 2001, outline an approach for automating and negotiating business contracts using an inference engine, and representing contracts as sets of business rules. However, because known inference processing techniques cannot resolve a result if a required goal is missing, these proposals require that the cooperative processing be performed in the one workspace, which effectively means the one inference engine. Therefore, to perform cooperative processing using known inference logic, one party must retrieve and/or be sent the inputs from all the cooperating parties. If no one party can be trusted enough to know all the inputs, or there are legal impediments to private inputs being disclosed, then the cooperative processing cannot be completed and these proposals are not practical.

Cryptographic theory proposes secure distributed protocols to share private inputs for processing without disclosing their values. These protocols rely on verifiable secret-sharing to provide an emulated trusted third party. There is normally a significant network overhead associated with a secure protocol, owing to the relatively large amount of data required to represent the encrypted secrets and the expected minimum of two communication rounds. In addition, the complex encryption calculations lead to high computational overheads.

In the context of adding functionality to commercial applications, a common rule-of-thumb is that an overhead for new functionality of greater than 50% indicates that the viability of the implementation should be questioned, and an overhead of 100% may mean the implementation is unacceptable. Secure protocols increase the computational overheads by significantly larger amounts, being typically more than six orders of magnitude (100,000,000%). For example, Ioannis Ioannidis and Ananth Grama in an article entitled “An Efficient Protocol for Yao's Millionaires' Problem” in Proceedings of the 36^{th} Hawaii International Conference on System Sciences, 2003, present an efficient protocol for comparing two numbers and report a computational overhead of 290 milliseconds for comparing two 20-bit numbers using Pentium III/450 Mhz computers. Even allowing 100 CPU cycles for the comparison of two (32-bit) numbers without a secure protocol, this is a ratio of approximately 3.5 per second compared to 4,500,000 per second, which represents an overhead of over one million to one.

Secure protocols are therefore impractical for many business applications where multiple multi-party computations are required to be carried out in short time flames or, in more extreme cases, in near real time. The problem is compounded when processing is being carried out across geographically dispersed hosts. Secure protocols typically try to provide an “ideal” level of security, equal to that where the computation is performed by a trusted third party. In the real world, if ideal security is not efficient enough for practical uses, a solution which provides an acceptable level of security may be preferred. Sacrificing some security or disclosing some limited information about private data is often acceptable in practice.

It is an aim of the present invention to provide a practical method and system for cooperatively processing the inputs of a plurality of parties using inference logic, in which there is no need for one party to know all the inputs, and the private inputs of each party are not disclosed to other parties.

### SUMMARY OF THE INVENTION

In one broad form, the invention provides a method of electronically processing a request for a result with a collaborative engine using inference logic, wherein the method includes the step of generating a partial result as a function of one or more unresolvable goals.

Typically, insufficient goals are provided to resolve the request, and the partial result is generated.

The partial result normally includes at least one goal capable of partially resolving the requested result.

The method may include the step of identifying unresolvable goals which are capable of partially resolving the request for a result, and the partial result is generated as a function of the identified unresolvable goals.

The method may include the step of retrieving at least one retrievable goal. Each retrievable goal is a goal that can be retrieved by the collaborative engine by means of a request for a goal. Each goal may comprise a fact, rule or other construct which can be used by the inference logic to resolve requests for results. The request for a result is processed as a function of goals. If sufficient goals are provided, the requested result is produced.

Typically, the inference logic comprises rules-based logic.

In this specification, the term ‘inference engine’ is intended to mean a process, or an apparatus executing a process, which seeks to derive desired information from a database or other knowledge base. Typically, the apparatus is a computing device or computing system, and the process is software driven. A ‘collaborative engine’ is an inference engine which is adapted to process information from or to multiple domains or systems which typically have some security restriction preventing full flow of information between them.

The step of generating a partial result as a function of one or more unresolvable goals may comprise creating a set of unresolvable goals and any goals the unresolvable goals rely on, and including the set in the partial result. A subset of the set of unresolvable goals may be further created, and included in the partial result.

The step of generating a partial result may further comprise masking at least one goal in the partial result. This may involve modifying the goal, or one or more goals that refer to the goal, and/or replacing the goal, or a value in the goal, with a generated goal or value that is known only to a collaborative engine performing the masking, or other processes in the same security domain as that engine.

The collaborative engine may comprise a sending collaborative engine, a receiving collaborative engine, or a transceiving collaborative engine.

In the case of a sending collaborative engine, the method may further comprise the step of (i) including the partial result with a further request for a result and transmitting that further request to at least one further collaborative engine or an executing piece of logic; or (ii) storing the partial result. Before transmitting the further request, a dynamic authentication token may be generated from one or more retrievable goals, for inclusion with that further request. The generated dynamic authentication token should not have been transmitted previously as a dynamic authentication token to the further collaborative engine(s).

In the case of a receiving collaborative engine, if the request for a result includes at least one goal capable of partially resolving the requested result and which is not a retrievable goal, the request for a result is processed as a function of retrievable goals and the at least one goal included in the request for a result. The request may include a dynamic authentication token for validation. The processing of the request may proceed if the dynamic authentication token is validated. Otherwise the processing is terminated if the validating fails.

In the case of a transceiving collaborative engine, if the request for a result includes at least one goal capable of partially resolving the requested result, the request is processed as a function of the retrievable goals and the at least one goal included in the request. Otherwise, the request is processed as a function of retrievable goals.

In one embodiment of the invention, the request for a result is processed with two or more collaborative engines. If insufficient goals are provided within the retrievable goals and, if applicable, the at least one goal included in the request for a result, to enable a collaborative engine to resolve the requested result, a partial result is generated. This partial result is included with a further request for a result which is transmitted to at least one further collaborative engine.

The present invention therefore enables multi-party processing of generic computations using inference logic. By using “workspace chaining”, inputs available to the workspace of one collaborative engine are resolved as far as possible and a partial result based on that processing is generated and transmitted for further processing in the workspace of another collaborative engine. There is no theoretical limit to the number of workspaces that can participate in this chaining. In addition, a collaborative engine can transmit a new partial result, generated in response to a partial result received from an initiating collaborative engine, back to the initiating collaborative engine. In this way, extended negotiation is efficiently supported.

The size of each data transmission between engines is kept small because partial results typically include only a subset of the set of goals involved in the specific computation, and the set of goals involved in the specific computation is typically significantly smaller than the set of goals capable of resolving the computation. In addition, often just a single transmission is required between two collaborative engines, even when the values within are masked. This is a significant improvement over the prior art. Known inferencing techniques must either transmit all goals that could be involved in the computation, or transmit each goal in a separate transmission. Secure protocols must transmit additional data in encrypted form and use two or more transmissions.

The computational overhead of deriving a partial result is small relative to computing the final result. This is because the overhead of adding unresolvable goals to a list and then traversing that list is low compared to the overhead of identifying, retrieving and resolving those goals. Similarly, the processing involved in masking a partial result is less than that used to complete all but the most trivial inference computations. Hence the overhead of masking a partial result is typically significantly less than the processing of the actual computation. At worst it is within an order of magnitude of it. This is a substantial improvement over secure protocols in which the overhead of masking is usually multiple orders of magnitude larger than the processing of the computation.

A further benefit of the present invention is that a partial result can be saved to persistent storage, eg disk or tape, and then processed when further input is available. This allows pausing of inference processing to wait for facts to be found, or the repeated reuse of one partial result to produce two or more subsequent requested results.

A further benefit of the present invention is that a computation requiring large amounts of resources can be divided amongst a plurality of collaborative devices. The present invention provides a generic mechanism for dividing inference processing, by generating partial results and passing them to other collaborative devices to continue processing. It will be readily understood that the topology of such a division can be arbitrarily complex, such that any collaborative device that receives a partial result for further processing can further delegate parts of that processing to one or more other collaborative devices.

In some embodiments, processing a request for a result as a function of retrievable goals and the at least one goal included in the request for a result may include differentiating between retrievable goals and goals included in the request for a result and may further include using such differentiation in the processing.

The generation of a partial result may be stipulated or prohibited, either as part of a request for a result, or through inferencing by the inference logic. If a partial result is prohibited, and not all goals which are identified as capable of partially resolving the result are resolved, then an error result may be generated.

The method of this invention can be utilised in many practical applications. For example, the request for a result may be

(i) a request for a routing path for electronic communication to or from a user of a communication network (and the method may include the step of retrieving at least one retrievable goal which is a fact or rule relating to the processing of electronic communications for that user);

(ii) a request for a routing path for a telephonic connection (and the method may include the step of retrieving at least one goal which is a fact or rule relating to the determining of a routing path for a telephonic connection for that user);

(iii) a request for a routing path for a communication message from or to a user of a network (and the method may include the step of retrieving at least one goal which is a fact or rule relating to the determining of a routing path for the communication message for that user);

(iv) a request for a management action for a component of an electronic data network (and the method may include the step of retrieving at least one retrievable goal which is a fact or rule relating to the management of that component);

(v) a request for a commercial transaction (and the method may include the step of retrieving at least one retrievable goal which is a fact or rule relating to the processing of the commercial transaction); or

(vi) a request to perform office-automation, workflow, calendar, or document management processing (and the method may include the step of retrieving at least one retrievable goal which is a fact or rule relating to office-automation, workflow, calendar, or document management processing, as the case may be).

In another aspect, the invention provides a method of electronically processing a request for a result with a collaborative engine using inference logic, wherein the method includes the step of processing a partial result as a function of one or more retrievable goals.

In another broad form, the invention provides a collaborative engine for electronically processing a request for a result using inference logic, wherein the collaborative engine includes means for generating a partial result as a function of one or more unresolvable goals. The collaborative engine is adapted to produce a partial result in the event that insufficient goals are available to resolve the request.

In another aspect, the invention provides a collaborative engine for electronically processing a request for a result using inference logic, wherein the request for a result includes a partial result, wherein the collaborative engine includes means for processing the partial result.

The apparatus of this invention can be utilised in many practical applications. For example,

(i) the collaborative engine may be connected to at least one communication network and adapted to process a request for a routing path for electronic communication to or from a user of the communication network (in which case the collaborative engine may retrieve at least one retrievable goal which is a fact or rule relating to the processing of electronic communications for that user);

(ii) the collaborative engine may be connected to at least one electronic data network and adapted to process a request to determine a management action regarding at least one component of that network (in which case the collaborative engine may retrieve at least one retrievable goal which is a fact or rule relating to the management of that component of the network);

(iii) the collaborative engine may be connected to at least one electronic data network and adapted to process a request to determine a commercial transaction for a user connected to that network (in which case the collaborative engine may retrieve at least one retrievable goal which is a fact or rule relating to the processing of the commercial transaction for that user); or

(iv) the collaborative engine may be connected to at least one electronic data network and adapted to process a request to perform office-automation, workflow, calendar, or document management processing for a user connected to that network (in which case the collaborative engine may retrieve at least one retrievable goal which is a fact or rule relating to office-automation, workflow, calendar, or document management processing for that user, as the case may be).

To assist in understanding the present invention and putting it into effect, embodiments thereof will now be described, by way of example, with reference to the accompanying drawings in which like numerals indicate like elements.

### BRIEF DESCRIPTION OF THE DRAWINGS

FIGS. 1a to 1c illustrate prior art inference logic.

FIGS. 2a to 2c illustrate basic examples of the inference logic of the present invention.

FIG. 3 is a block diagram of a distributed data processing system comprising two interconnected collaborative devices which perform multi-party processing according to the present invention.

FIG. 4 is a flowchart illustrating inference logic executed in each collaborative device of FIG. 3.

FIGS. 5, 6 and 7 are examples of rules and facts, which are used to describe the logic of FIG. 4.

FIG. 8 depicts a distributed data processing system in which a plurality of collaborative devices perform multi-party processing according to the present invention.

### DETAILED DESCRIPTION OF PREFERRED EMBODIMENTS

An understanding of the present invention will be facilitated by an understanding of prior art inference logic. The basis of known inference logic is to identify and process the goals required to determine the desired result. In this context, a goal may define a value for some piece of information, or may define how one or more goals can be resolved from one or more other goals. Goals that define a value are commonly called ‘facts’ and may define a simple value (eg ‘10’) or a complex state (eg the state of a customer record or object). Goals that define how to resolve other goals are commonly called ‘rules’ and may: define relationships between facts (eg “if CUSTOMER=Customer-A then DISCOUNT=10%”); constrain facts (eg “10%<DISCOUNT<15%”); or define relationships between combinations of facts and rules (eg “if CUSTOMER=Customer-A then 10%<=DISCOUNT <=15%”). Implementations of inference logic vary, and the exact nature of goals is determined by the implementation. Similarly, the nature of a request for a result varies with the implementation of the inference logic. For example, depending on implementation, a request for a result can include asking for one or more values, asserting one or more new values, combinations of these, or further forms.

The inference logic identifies the goals that are required to determine the result, and then identifies and retrieves further goals that are required to resolve the goals already identified. The process of moving from one goal to the next may be referred to as chaining, and there are two primary forms of chaining known in the art: forward chaining and backward chaining. In forward chaining, resolving a first goal may affect one or more secondary goals, causing them to also be resolved. In backward chaining, resolving a first goal is postponed until one or more secondary goals have been resolved, so that the results of the secondary goals are available for resolving the first.

The inferencing process typically continues until either the desired result is resolved, or no further goals can be identified, although it is possible that the process is terminated prematurely, for example by an external command. If the inferencing process has stopped before a result has been determined because no further goals can be found, then no result is produced. This indicates that insufficient goals are available to determine the result and is often signalled as an error by the inference logic.

In the process of inferencing, the logic may identify a goal that it finds cannot be resolved, either because it cannot be retrieved, or because it depends on a secondary goal that cannot be resolved. The inference logic marks all such goals as unresolvable, which ensures the logic will not attempt to resolve these goals again. If unresolvable goals are not marked as such, then the inference logic could attempt to resolve them again, and could therefore loop forever. Since known inference logic cannot use such unresolvable goals to determine the result, unresolvable goals are discarded.

Therefore, two characteristics of known inference logic are that unresolvable goals are identified and discarded, and that processing stops, possibly without producing a result, when no new, unresolved goals can be identified.

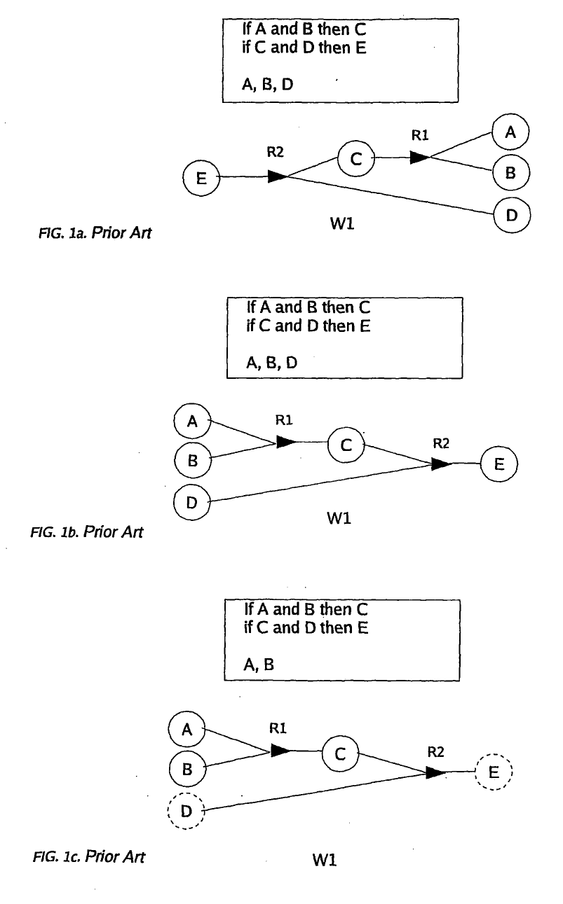

A simple example of prior art inference logic is illustrated in FIGS. 1a to 1c. In these illustrations, reference is made to example rules and facts, collectively referred to as goals, which are listed here in Table 1 below.

TABLE 1

| goal | content |
|---|---|
| Rule R1 | If A and B then C |
| Rule R2 | If C and D then E |
| Fact 1 | A |
| Fact 2 | B |
| Fact 3 | D |

Referring to Table 1, the example rules R1 and R2 have a similar form (if X and Y then Z) but it will be readily understood that rules may take any form understandable to the inference logic.

Referring to FIG. 1a, result E is resolved in an inference workspace W1, from facts A, B, and D using backward chaining. If result E is requested, then the logic infers that rule R2 can resolve the request. The logic further infers that rule R1 can resolve fact C, which is required by rule R2, and so by resolving rules R2 and R1, result E is resolved.

Referring to FIG. 1b, result E is resolved in an inference workspace W1, from facts A, B, and D using forward chaining. If a new value is asserted for, say, fact A, the logic infers that rule R1 is affected by fact A, and resolves that rule (which also requires fact B). Resolving rule R1 asserts a new value for fact C, which causes the logic to process rule R2, (which also requires fact D), and so by resolving rules R1 and R2, result E is resolved.

The primary difference between the logic diagrams in FIGS. 1a and 1b is in the direction of the arrows, which denote the direction of the inferences. In backward chaining, the inferences chain away from the result, and in forward chaining, they chain towards the result. A general method applied to inference logic can be applied to forward and backward chaining, and combinations of the two.

Referring now to FIG. 1c, result E cannot be resolved because fact D cannot be resolved. In this example, fact D cannot be resolved because there are no rule goals that can produce D, and no value for D can be retrieved into workspace W1. Considering the logic illustrated in FIGS. 1a and 1b, rule R2 cannot be resolved if a value for fact D cannot be resolved in the same workspace as rule R2, and therefore, known inference logic can only resolve result E if a value for fact D can be retrieved into workspace W1. There are methods for locating and retrieving a value for fact D into workspace W1, but these methods do not address the situation in which fact D cannot be retrieved, for example because it represents data private to another workspace.

With reference to FIG. 1c, goal D may be termed ‘not retrievable’, in contrast to goals A, B, R1 and R2 which may be termed ‘retrievable’. For the purposes of this document, a retrievable goal is a goal that can be retrieved into a workspace from a knowledge base on request. If the inference logic can send a request for a goal to a knowledge base, and receive that requested goal in reply, then that goal is retrievable.

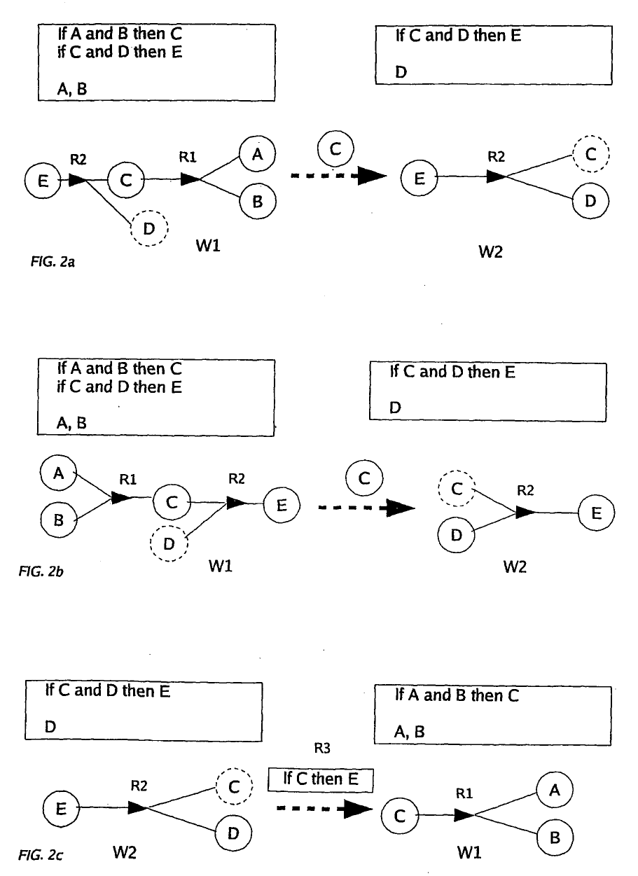

A simple example of the inference logic of the present invention will now be described with reference to FIGS. 2a to 2c in conjunction with Table 1. These illustrate result E being resolved in two separate workspaces, W1 and W2, wherein facts A and B are not disclosed outside of workspace W1, and fact D is not disclosed outside of workspace W2.

Referring to FIG. 2a, backward chaining is used in workspaces W1 and W2 to resolve result E. Fact C is resolved in workspace W1 from facts A and B, but fact D cannot be resolved in workspace W1. Instead of stopping without producing a result, a partial result is produced from the contents of workspace W1, comprising fact C. In this example, fact C already masks facts A and B, so the partial result may be passed, without modification, to workspace W2, without disclosing facts A and B. Fact C from the partial result is used in conjunction with rule R2 and fact D to resolve result E in workspace W2.

Referring to FIG. 2b, the same scenario is illustrated, but with forward chaining being used in both workspaces instead of backward chaining. If a new value for fact A is asserted to workspace W1, then rule R1 will be resolved, which will assert a new value for fact C. Rule R2 is affected by fact C, but since fact D cannot be resolved in workspace W1, rule R2 cannot be resolved either. In this example, a partial result containing fact C is passed to workspace W2. The value of C from the partial result is asserted to workspace W2, which causes rule R2, and consequently result E, to be resolved. It will be readily understood that combinations of backward and forward chaining are also possible.

Referring to FIG. 2c, backward chaining is used to resolve result E, as in FIG. 2a, but with the order of processing reversed. In this example, rule R2 cannot be resolved in workspace W2, so a partial result is produced containing fact D and rule R2. This could be passed to workspace W1, but that discloses both fact D and rule R2. Fact D and rule R2 can be masked by factoring the known fact D out of the partially resolved rule R2. In this example, fact D is known to be true, so rule R2, “if C and D then E” is re-factored to the new rule R3, “if C then E”. The partial result containing R3 is then transmitted to workspace W1. In workspace W1, fact C is resolved from facts A and B, and thence result E, using rule R3 from the partial result.

Rule R3 is not a retrievable goal for either workspace W1 or W2. A request such as “retrieve R3” cannot return a result because rule R3 does not physically exist in a knowledge base. There is no identifier “R3” or other selection criteria that could be used to retrieve rule R3. In contrast, rule R2 is a retrievable goal. A request such as “retrieve all goals that resolve E and rely on D” can retrieve rule R2 into workspace W2. Rule R2 is a retrievable goal for workspace W1 only if rule R2 is allowed to be disclosed to workspace W1. A request such as “retrieve all goals that resolve E” can retrieve a set of goals (in this example, rule R2 and fact D) into workspace W2, but does not retrieve rule R3. If one of the goals in this set is not retrievable for workspace W1 (because, for example, it is private and is not allowed to be disclosed to workspace W1), then the entire set is not retrievable for workspace W1. Rule R3 is the result of processing this set of goals in the context of a specific request for a result. Therefore, a request for rule R3 must take the form of a request for a result, for example “return the result of trying to resolve E”. Such a request for a result is not a request for a goal from a knowledge base; it is a request for processing.

It will be readily understood that the partial result in FIGS. 2a and 2b may also be masked using the same technique as used in FIG. 2c. In this case, the resolved fact C is factored out of rule R2, so rule R2 “if C and D then E” is re-factored to produce a new rule, for example, “if D then E”. This new rule is then passed, in a partial result, to workspace W2 which then uses that new rule to resolve result E. It will also be readily understood that this new rule, like fact C, is not a retrievable goal.

The logic illustrated in FIGS. 2a to 2c can be utilised to process a single computation in multiple inference workspaces through “workspace chaining”, in which the inputs available to one workspace are resolved and a partial result based on that processing is generated. This partial result is then passed to a second workspace for further processing using the inputs available to the second workspace, including the partial result.

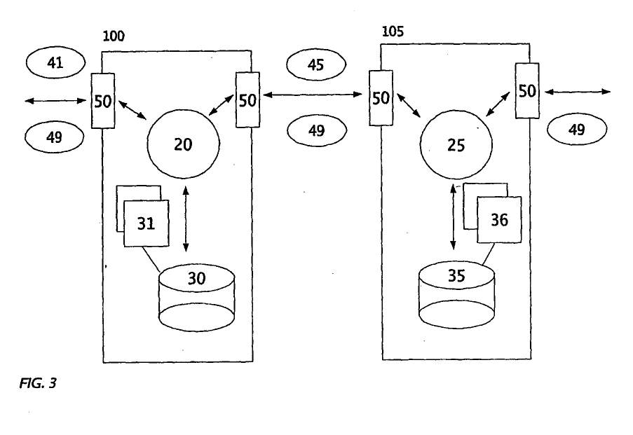

Referring to FIG. 3, collaborative devices 100 and 105 may each be a general purpose computing device, such as a server, workstation, laptop, etc, or may be a dedicated device implemented using a microprocessor with associated memory and input/output devices, or may be electronic circuitry such as one or more integrated circuits and associated hardware. Advantageously, collaborative devices 100 and 105 are configured to be capable of processing multiple collaborative computations simultaneously, for example through time-slicing, or multiple processors.

Communication ports 50 are used to connect each collaborative device to external components including further collaborative devices, and references in this document to collaborative devices or collaborative engines communicating with other devices or engines implicitly refer to the use of communication ports 50 for such communication. Communication ports 50 may be Ethernet ports, USB ports, and/or serial ports, etc, which are known in the art. Each collaborative device may receive requests from, and send results to, an external party such as a person, a computer program, an executing piece of computer logic, or any other agent capable of sending a request and/or receiving a result. Additionally, collaborative computations may be initiated automatically by a collaborative device on some event, such as time, date, or a particular status.

Collaborative devices 100 and 105 are typically implemented as independent devices, but may also be implemented as components to be coupled to one or more other devices, for example as circuit boards to be plugged into compatible computing devices, or as one or more integrated circuits to be connected with further integrated circuits.

Collaborative devices 100 and 105 contain collaborative engines 20 and 25 respectively, which execute the logic of the present invention and may be embodied in one or more computer programs, libraries of computer-executable code, in machine code for a microprocessor, or in electronic circuitry such as one or more integrated circuits. Collaborative engines 20 and 25 can each access one or more workspaces (not shown). A workspace is an area of memory used by the logic of the present invention to resolve inference goals. The memory for the workspaces may be embodied in one or more dedicated integrated circuits, or may be kept in the memory of the collaborative device. The logic for managing the workspaces may be implemented as part of the logic of the present invention, in one or more computer programs, libraries of computer executable code, in machine code for a microprocessor, or in electronic circuitry such as one or more integrated circuits.

Collaborative engines 20 and 25 interface with data stores 30 and 35 respectively, to retrieve goals for inference processing. Data stores 30 and 35 may be embodied in one or more computer programs such as indexed files or a database, or alternatively in non-volatile memory and associated control logic. Data stores 30 and 35 may be internal to collaborative devices 100 and 105 respectively, as shown, or may be external.

Each collaborative engine implements inference logic that is capable of distributing the processing of a single computation across multiple engines, through the addition of three features to known inference logic.

1) When an unresolvable goal is identified, it is not discarded but is added to a list of unresolvable goals. Unresolvable goals are marked as unresolvable as in known inference logic, as the collaborative engine could otherwise loop forever. The unresolvable goal list may be implemented as a vector or array of elements, a dynamic array, or a similar structure.

2) When no new unresolved goals can be identified, a partial result may be produced. The partial result is produced as a function of unresolved goals, being those currently in the workspace and those in the list of unresolvable goals, since these are all known to be goals that could resolve the final result. Thus the partial result represents knowledge that a second collaborative engine could use to resolve the desired final result, given that the second collaborative engine can resolve one or more of the unresolved goals from the partial result. Typically, the partial result includes the unresolved goals and the goals on which they rely, encoded into a form acceptable to a collaborative engine. There are many encodings for inference goals known in the art including non-proprietary encodings such as RuleML.

3) When a partial result is received, the goals within are decoded and made available to the inference logic, so they may be used in the inference process in the usual way. Decoding techniques such as lexical analysers and parsers are known in the art. The decoded goals are instantiated into a form understandable to the inference logic, typically using logic the same as, or similar to, that already used to instantiate goals retrieved into the workspace. The decoded goals may be stored in a temporary data store or knowledge cache within the collaborative engine, in such a form that the inference logic may retrieve them as needed. Goals in the temporary data store may be removed once they are no longer needed.

It will be understood that a collaborative engine that implements all three modifications is capable of both sending and receiving a partial result (ie, it is a “transceiving” collaborative engine). Further embodiments may implement a subset of these three modifications. For example, a send-only collaborative engine may be constructed by implementing modifications 1 and 2 only, thereby producing an engine capable of generating and sending a partial result, but not receiving one. Similarly, a receive-only collaborative device may be constructed by implementing modification 3 only.

Preferably, when generating a partial result, the collaborative engine may also mask goals in that partial result Advantageously, the logic for this is embodied in a set of goals that can be understood by the collaborative engine, although it may also be embodied in discrete logic such as computer programs, microprocessor machine code, or one or more integrated circuits. A goal may be masked by modifying the goal itself (eg a fact goal may be masked by modifying the value of the fact), or by modifying the goals that refer to that goal (eg a rule goal may have a fact or rule factored out). However, not all goals are necessarily masked. It will be understood that the following observations hold true.

A goal is unresolvable if it cannot be retrieved, or if it refers to one or more secondary goals that cannot be resolved.
A goal that cannot be retrieved into a workspace cannot be masked, nor can it be private to that workspace.
A goal that refers to no secondary goal (eg a fact goal), can only be unresolvable if it cannot be retrieved, in which case it is a goal as described in the paragraph above.
A goal that is resolved can always be factored out of any goals that refer to it, and so need never be included in a partial result.
A goal that refers to one or more secondary goals can have resolved secondary goals modified and/or refactored and/or factored out, and secondary goals factored in.
From these observations it will be understood that the following four masking techniques are sufficient to mask goals in a partial result, should this be required (eg because the goal, or a goal it refers to, is private):
a) A resolved secondary goal may be masked by being modified. For example “993.02” in “if A<$993.02 then C” can be modified by rounding the value in the direction of the operator, resulting in, for example “if A<$950 then C”.
b) A resolved secondary goal may be masked by being factored out. For example, B in “if A and B then C” can be factored out resulting in “if A then C” or “not C”, depending on the resolved value of B.
c) A resolved secondary goal may be masked by re-factoring. For example, “if A>100 then A=100” can be re-factored to “A <=100” which has changed the direct reference (the equality operator) to an indirect reference (the less-than-or-equal-to operator).
d) A goal that refers to one or more secondary goals may have resolved and/or unresolved goals factored in and/or out. For example, “if A<B+C then D” can be refactored to “if A<X then D” or “if A+Y<Z then D”, depending on what other goals exist that refer to A and B.

It will be readily understood that further techniques for masking values may be implemented, depending on the representation of goals used in the collaborative engine. In addition, application-specific information can be used to mask values. For example, a private value “100” can be replaced with a unique identifier “abc”. If the identifier “abc” is subsequently encountered by a process with access to the original private data, then the identifier “abc” can be replaced by the original value “100”. It will also be understood that an embodiment may specify the behaviour for the cases in which private data cannot be masked, for example, an error may be produced, the data may be included unmasked, or alternative processing may be invoked.

Preferably, a collaborative engine can differentiate between goals decoded from a received partial result and goals retrieved from a data store, and can use this differentiation in processing, whilst always allowing transparent access to all goals by the inference logic. Transparent access to all goals ensures that all appropriate goals are used by the inference logic, regardless of their origin. The ability to differentiate allows the collaborative engine to include the origin of a goal in the processing, for example to automate the resolution of conflicts between goals. There are many ways to implement the differentiation between goals, such as marking each instantiated goal with its origin, or maintaining an association between a goal and its origin, using a hash table or similar structure.

Collaborative engines may be constructed by modifying a known inference engine, or by constructing a new inference engine that incorporates the particular features of the present invention. The logic of known inference engines can: identify unresolvable goals; detect that no further goals can be identified; and initiate processing in response to input. Therefore, the locations may be readily identified within existing logic or a new design, for the logic of the present invention. For example, an existing inference engine embodied in a computer program written in an object oriented programming language, such as Java or C++, may be modified by making changes to the appropriate methods of the appropriate classes, by defining newly derived classes, or by creating further methods and/or classes. Corresponding techniques may be employed to modify machine code implementations, or electronic circuit designs. There are many existing implementations of inference engines, both in hardware and computer software. Such implementations may be proprietary, or freely available to the public.

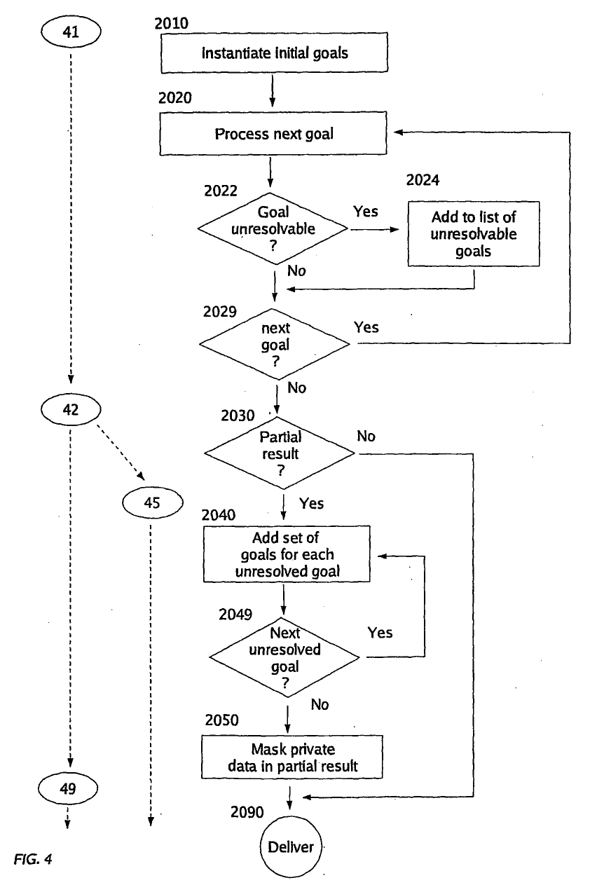

The logic illustrated in FIG. 4 is now discussed with reference to the apparatus of FIG. 3, and an illustrative example in which a request for a result, request 41, is received by collaborative device 100. Collaborative device 100 processes request 41 in collaborative engine 20 as a function of goals retrieved from data store 30, resulting in partial result 45 being generated and included in a request for a result sent to collaborative device 105 for further computation. Collaborative device 105 processes this request in collaborative engine 25 as a function of the goals in partial result 45 and goals retrieved from data store 35, producing final result 49. In this example, final result 49 is transmitted by each collaborative device to an external party (not shown). In FIG. 3, lines with arrows represent communication of data between elements.

The logic begins at block 2010 with collaborative engine 20 receiving request 41. Collaborative engine 20 instantiates (at block 2010) the inference goals associated with request 41, by decoding any partial result included with request 41, and retrieving goals by querying data store 30. Preferably, collaborative engine 20 does this in a way such that it can differentiate between goals from the partial result and goals retrieved from data store 30 (e.g. to resolve conflicts between goals) whilst allowing the inference logic transparent access to all goals. In this example there is no partial result included with request received by collaborative engine 20.

Collaborative engine 20 processes (at block 2020) the instantiated goals in its workspace using inference logic. The inference logic instantiates further goals required to resolve any current goal, by retrieving them from data store 30, and performs zero or more actions as a result of resolving each goal. Inference logic is known in the art, and may include forward or backward chaining logic, combinations of these, or other inference logic.

If collaborative engine 20 determines (at block 2022) that a goal cannot be resolved, then it adds (at block 2024) the unresolved goal to the list of unresolvable goals.

If collaborative engine 20 determines (at block 2029) that there is at least one next goal that is unresolved and not unresolvable, then the logic proceeds back to block 2020.

If there is no next goal, then all goals applicable to this computation have been identified and processed by collaborative engine 20, resulting in workspace state 42, which may contain both resolved goals, and unresolved goals now known to be unresolvable, since no further goals can be identified.

Collaborative engine 20 decides (at block 2030) whether or not to generate partial result 45. Collaborative engine 20 decides to generate partial result 45 if one or more goals required by request 41 are unresolved, and if a partial result is not prohibited. A partial result may be stipulated or prohibited, explicitly by request 41, or implicitly through the processing of the goals associated with request 41. If collaborative engine 20 decides (at block 2030) not to generate a partial result, the logic proceeds to block 2090, where a final result is delivered. In this case, the final result may be an error if one or more goals are unresolved. If the collaborative engine decides to generate a partial result, the logic creates an empty partial result 45, and proceeds to block 2040.

Collaborative engine 20 adds (at block 2040), for each unresolved goal, being those currently in workspace state 42 and those in the list of unresolvable goals, a set of goals to partial result 45. This logic recursively adds to the partial result all goals referenced by each unresolved goal, plus all goals referenced by any unresolved goal already in the partial result. This logic may be embodied in inference goals resolvable by the collaborative engine. Further logic or inference goals may additionally be used to optimise, trim, or refactor the goals in the partial result. In some embodiments, the logic first adds all currently unresolved goals to the list of unresolvable goals, and then adds all goals in the list of unresolvable goals, plus those goals they refer to, into the partial result.

If collaborative engine 20 determines (at block 2049) that there is a next unresolved goal the logic proceeds to block 2040.

Collaborative engine 20 identifies (at block 2050) any goal in partial result 45 that is private. The collaborative engine may do this by querying data store 30 to determine any access restrictions on each goal. Collaborative engine 20 then masks the private data by modifying each private goal, and/or re-factoring any goals that refer to private goals.

Collaborative engine 20 may optionally add (at block 2050) further goals to partial result 45 that define how possible conflicts or ambiguities involving goals in partial result 45 can be handled. This could be done by deriving metrics or constraint goals that define the precedence of one goal relative to another using, for example, precedence information in the form of metrics or goals stored in data store 30. Precedence goals and metrics in inference logic are known in the art.

Collaborative engine 20 delivers (at block 2090) the partial result to one or more next collaborative engines. Collaborative engine 20 does this by identifying at least one next collaborative device either directly from request 41, or through resolving inference goals, and delivering the partial result to that collaborative device for processing by the collaborative engine associated with that device. In this example, partial result 45 is included with a request for a result transmitted to collaborative device 105 which is processed by collaborative engine 25 using the logic just described.

Collaborative engine 25 instantiates (at block 2010) the goals from partial result 45 as well as goals from data store 35. Collaborative engine 25 resolves all goals required to produce the requested result, and therefore does not have any unresolved goals in its list of unresolvable goals. Collaborative engine 25 therefore decides (at block 2030) not to produce a partial result, and so proceeds to block 2090 where final result 49 is generated and delivered.

The logic illustrated in FIG. 4 is capable of both sending and receiving a partial result, as per a transceiving collaborative engine. In a different example, the logic could begin with collaborative engine 25 receiving a request for a result and, if (at block 2030) one or more goals required to produce the result are unresolved, then collaborative engine 25 could generate a partial result which is then delivered to collaborative engine 20 for further processing. It will be readily understood that a send-only or receive-only collaborative engine uses similar logic with some parts removed, and therefore does not depart from the scope of the present invention.

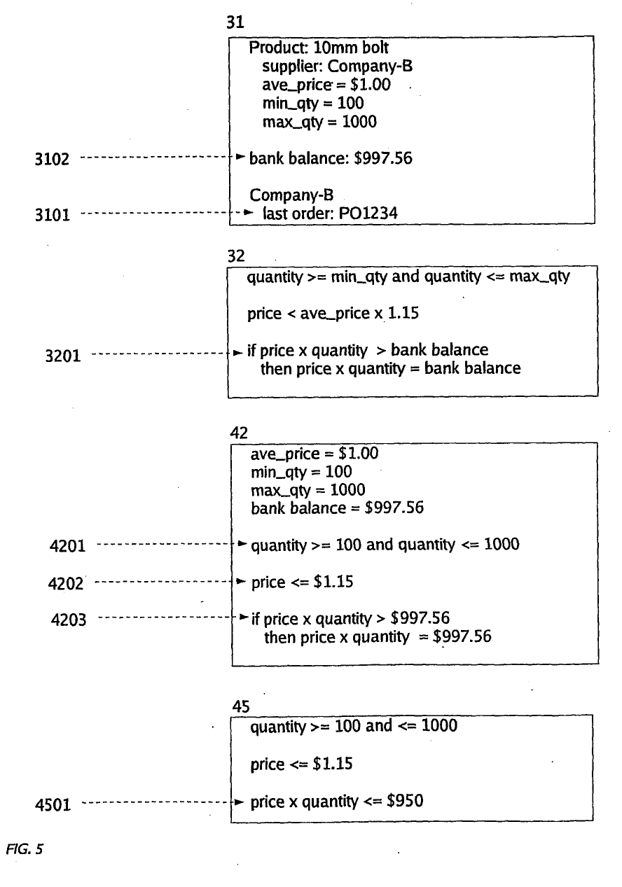

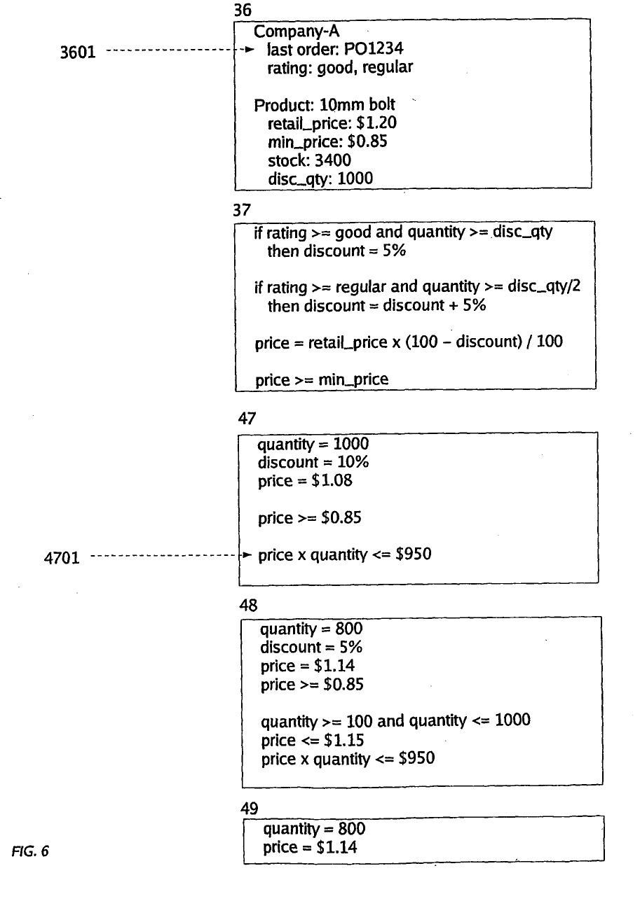

FIGS. 5 and 6 illustrate an example of goals for collaborative engines 20 and 25, which are used by Company-A and Company-B, respectively. In this example, the goals comprise rules and facts. It will be understood that this is a simplified example and that the rules are illustrative only, and may be in any form understandable by collaborative engines 20 and 25. Referring to FIG. 5, dataset 31 and ruleset 32 are stored in data store 30, and illustrate example facts and rules respectively for Company-A regarding a purchase. Workspace state 42 represents the state within collaborative engine 20 at a particular point in time, and partial result 45 illustrates the partial result generated by collaborative engine 20. Referring to FIG. 6, dataset 36 and ruleset 37 are stored in data store 35, and illustrate example facts and rules respectively for Company-B regarding a sale. Workspace states 47 and 48 represent the state within collaborative engine 25 at particular points in time, and final result 49 illustrates the result of the example request, generated by collaborative engine 25.

An example of an automated purchase of a quantity of bolts by Company-A from Company-B will be described with reference to FIGS. 3 to 6 inclusive. In response to purchase request 41, collaborative engine 20 sets “price” and “quantity” as its goals, and proceeds using dataset 31 and ruleset 32. Collaborative engine 20 arrives at the state illustrated in workspace state 42, wherein those rules that could resolve “price” and “quantity” have been retrieved into the workspace, the facts referenced by those rules that could be retrieved from data store 31 have also been resolved, and no further goals can be identified. Rules 4201, 4202, and 4203 are unresolved in workspace state 42, since they refer to the unresolved goals “price” and “quantity”. Collaborative engine 20 therefore creates partial result 45, and adds unresolved goals 4201, 4202, and 4203 into the partial result. In this example, no goals were identified as unresolvable before workspace state 42 was reached, and so the list of unresolvable goals is empty. In addition, the unresolved goals only refer to secondary goals which are resolved, and so no further goals are included in the partial result.

Collaborative engine 20 then checks data store 30 to determine if any goals in partial result 45 are private. Regardless of whether rule 3201 is private, fact 3102 is private, and so, therefore, is any goal that refers to it, including rule 4203. Collaborative engine 20 modifies the partial result by deriving a new rule 4501 from rule 4203, since rule 4203 refers to a private fact. Rule 4501 is generated by masking the private data, in this case the value $997.56, which discloses the bank balance 3102. The value is masked by factoring out the if-clause of the rule. In doing so, the greater-than operator in the if-clause is re-factored into the then-clause, which causes it to be “inverted”, resulting in a less-than-or-equal operator. In this example “if price×quantity>$997.56 then price×quantity=997.56” is re-factored to be “price×quantity<=997.56”. Since the rule no longer contains an equality operator, it is no longer a direct reference to the private value.

The value may be further masked by rounding it in the direction of the operator, to a multiple of some reasonable value. In this example, the value is rounded to a multiple of $50, resulting in the value $950.00. After this process, partial result 45 contains no direct or indirect references to private data. In this example, the masking logic is implemented in inference rules (not shown).

Collaborative engine 25 receives partial result 45 and proceeds to resolve the partial result using dataset 36 and ruleset 37. After processing the rules in ruleset 37, collaborative engine 25 has resolved values for “quantity” (1000; a value consistent with the rules in partial result 45) discount (10%), and price ($1.08), resulting in the state illustrated in workspace state 47. However, when collaborative engine 25 considers rule 4701, a new value for “quantity” will be resolved, since 1000×$1.08 is greater than $950. In response to this, collaborative engine 25 resolves a new value for “discount”, arriving at the state illustrated in workspace state 48. Since the requested goals “price” and “quantity” are now resolved, and all values in workspace state 48 are consistent with all the rules, collaborative engine 25 produces final result 49 which it can return to collaborative engine 20.

It will be readily understood that collaborative engines 20 and 25 have negotiated a multi-party computed result using inference logic, without disclosing private goals to the other collaborative engine. In this example, the goals within partial result 45 allowed negotiation without need of a second exchange of communication. Had collaborative engine 25 been unable to resolve all goals, it could have sent a second partial result to collaborative engine 20 for further processing. In this way, extended negotiation is supported.

It will be understood that there is no theoretical limit to the number of collaborative engines involved in such computations. In a different example, collaborative engine 25 resolves some, but not all of the unresolved goals, and generates a partial result to send to a third collaborative engine (not shown). By specifying whether a partial result may or may not be produced, each collaborative engine can exert control over when the final result is produced. For example, collaborative engine 20 could inform collaborative engine 25 that a partial result is required, thereby ensuring that collaborative engine 25 does not generate a final result, so that a third collaborative engine can also be involved in the computation. Similarly, collaborative engine 20 could inform collaborative engine 25 that a final result is required, forcing collaborative engine 25 to generate either a final result, or an error, if this is not possible.

Partial results may also be sent to destinations other than another collaborative device. Partial results may be sent to an executing piece of logic, either to be forwarded to one or more collaborative devices, or for other processing. Partial results may also be stored in and/or retrieved from transient storage (eg to be shared amongst collaborative devices), or may be saved to persistent storage such as disk or tape.

In another embodiment, the present invention is applied to the routing of telephone calls in an Intelligent Network (IN) communication network.

There would be significant additional benefits to customers if the communication network could take into account the preferences of both calling and called parties. This would enable call routing decisions that match the combined preferences of both parties better Man known techniques in which the preferences of each party are considered in isolation. For calls involving call-diversion, there would also be significant benefits in terms of more efficient routing and more efficient use of trunks, if a combined decision were available at the originating network. This would enable calls to be directly routed to their ultimate destination. With conventional call-diversion, calls are routed by the calling party's network to the called party's network, which then diverts the call to the ultimate destination. The second leg of such a call-diversion call comprises a second call which is normally charged to the original called party.

Known inference logic requires the inference result to be produced in a single inference engine, but user preferences may contain private information, such as telephone numbers and contact details, which cannot be shared with other networks. At the same time, telephone networks typically need to resolve tens, hundreds, or even thousands of routing paths per second and there are strict constraints on total elapsed time for the routing to be completed. For example, a response to a query for a routing path might need to be given in less than 250 milliseconds. The present invention provides a practical solution for using inference logic to compute routing paths using the preferences of both calling and called parties.

The example will consider the routing of a telephone call between a calling party, Alice, and a called party, Bob. In this example, Alice uses her mobile phone to call Bob, who is a business contact, on his mobile phone at 6:00 pm. Alice and Bob are customers of different mobile networks. Alice knows that some of her business contacts work from home and sometimes redirect their mobile calls to their home phone. Whilst Alice is happy for her calls to be redirected to a home phone during business hours, she wishes them to be redirected to voicemail instead, if the recipient's local time is later than 5:30 pm. Bob wishes to be able to activate an “at home” mode which redirects all calls made to his mobile to his home phone. He also wishes to have all calls, other than those from specified important callers, redirected to voicemail after 9:00 pm.

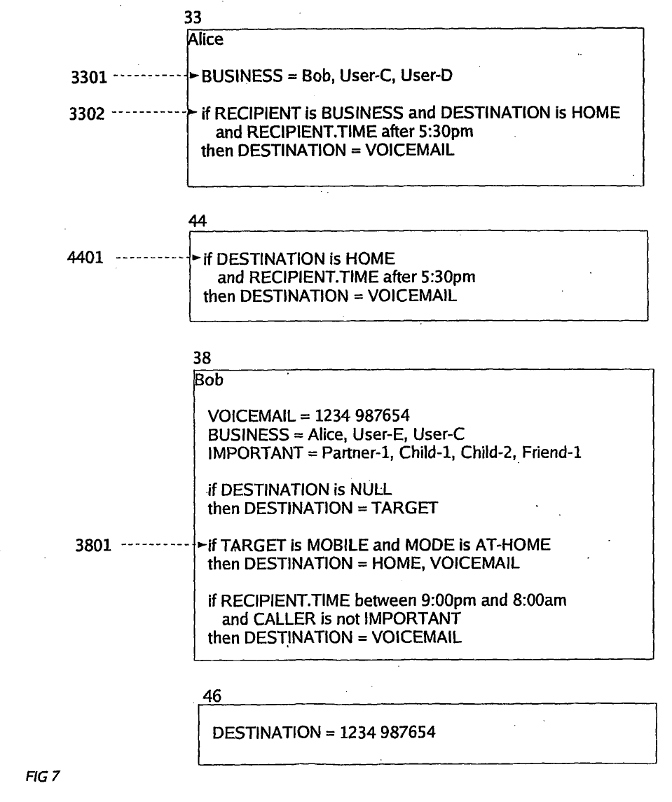

Referring to FIG. 7, Alice's and Bob's preferences, expressed as rules and facts, are stored in knowledge bases 33 and 38 respectively. For example, rule 3302 specifies Alice's preference that calls to business contacts are routed to their voicemail rather than their home phone after 5:30 pm, and rule 3801 specifies Bob's preference that when “AT-HOME” mode is active, calls to his mobile are routed to his home phone, or voicemail, in that order. It will be understood that this is a simplified example, and that the rules are illustrative only.

Referring also to FIG. 3, Alice's mobile network is connected to collaborative device 100, and Bob's mobile network is connected to collaborative device 105. Knowledge base 33 is stored in data store 30 and knowledge base 38 is stored in data store 35. When Alice dials Bob's number, Alice's mobile network initiates an IN query for call processing instructions. This query is forwarded as a request for a result to collaborative device 100 which processes it in collaborative engine 20. It should be noted that the request for a result, the partial result, and the final result for this example are not shown in FIG. 3 or 4.

Referring to the logic of FIG. 4, collaborative engine 20 resolves “RECIPIENT is BUSINESS”, but rule 3302 is unresolvable because “DESTINATION” cannot be resolved. Since there are no further rules that can be resolved, collaborative engine 20 produces partial result 44. In this example, fact 3301 is private and so rule 3302 is re-factored to remove fact 3301, resulting in the new rule 4401. Collaborative device 100 then sends a request for a result which includes partial result 44 to collaborative device 105 which processes it in collaborative engine 25.

Collaborative engine 25 receives partial result 44 and proceeds. In this example, Bob has his “AT-HOME” mode activated, and therefore collaborative engine 25 resolves “DESTINATION=HOME, VOICEMAIL” from rule 3801. Collaborative engine 25 can now resolve rule 4401, from partial result 44, which resolves “DESTINATION=1234 987654”. Collaborative engine 25 can now produce final result 46. In this example, collaborative device 105 sends final result 46 to collaborative device 100, which can return it as the response to the original query, providing a routing path.

There are numerous way to implement the logic that allows Alice's preferences to modify Bob's. In this example, collaborative engine 25 differentiates between goals from partial result 44, and goals retrieved from data store 38, and Alice's rule 4401 is only allowed to modify Bob's if it specifies a DESTINATION that is currently also acceptable to Bob's preferences. Since Alice's rule 4401 specifies “DESTINATION=VOICEMAIL”, and Bob's rule 3801 also specifies VOICEMAIL as an acceptable DESTINATION, Alice's modification is accepted. An alternative implementation could list destinations in order of privacy, and only allow modification from Alice's rules that select an equally or less private destination. In this way, a modification from a home phone to voicemail might be accepted, whereas a modification from a home phone to a mobile phone might not be accepted. Ideally, such logic would also be implemented as rules, so it may be tailored by each user. In any implementation, if the rules conflict such that no DESTINATION can be selected, then the connection cannot be made, and the result returned to the originating network could instruct that an announcement be played informing Alice that the call cannot be completed at this time.

In the preceding example, if Alice had called before 5:30 pm, the final result returned to collaborative device 100 would have been Bob's home phone number, and Alice's call would have been routed directly to Bob's home phone. With conventional call-diversion, Alice's call would have been routed to Bob's mobile network which would, if call-diversion were enabled, make a second connection to Bob's home phone on the PSTN. In this case, network resources for two calls would be consumed for the duration of the call.

The routing path for a call between Alice and Bob is efficiently computed, using the preferences of both parties, without disclosing private information. The processing overhead of producing and masking partial result 44 is small, and the network transmission overhead is also small. There is only one transmission from collaborative device 100 to collaborative device 105, and its content, partial result 44, is small (usually significantly smaller than Alice's preferences). The single reply transmission from collaborative device 105 to collaborative device 100 contains final result 46, which is also small (usually smaller than partial result 44). Alternative techniques, such as transmitting all of Alice's or Bob's preferences, either as rules or parameters, would include larger transmission overheads, and possibly larger processing overheads. Because routing paths must be computed in restricted timeframes, known secure protocols, with their high computational and network overheads, could not be used for securing Alice's and Bob's preferences.

It will be readily understood that Alice's network need not know that final result 46 includes information from any preferences other than Alice's. From the network's point of view, a query is made and a response is received. In the case of IN networks there is no need to change the network logic or mode of operation. This means collaborative devices can be incorporated into existing networks with minimum integration work.

It will also be readily understood that if only one of the networks involved in a call uses a collaborative device, then that network still enjoys the benefits of using inference logic for processing preferences, albeit without the benefits of collaborative processing. When each party's network uses a collaborative device, the additional benefits of collaborative processing, including routing paths that better match the combined preferences of both parties, and the possibility of negotiation between collaborative engines, are realised. Furthermore, more than two collaborative devices, and hence more than two networks, can be involved in such collaborative processing.

Generating routing paths using collaborative inference processing is extremely flexible. For example, Bob's rules and/or network could prohibit exporting some or all of Bob's phone numbers. Collaborative engine 25 could instead return a virtual phone number to Alice's network. When Alice's network creates a connection to this virtual number on Bob's network, Bob's network makes an IN query to determine the correct destination for this virtual number, resulting in the call being routed as previously determined by collaborative engine 25.

In a further example, Bob has an additional rule which states “if DESTINATION is VOICEMAIL and CALLER is BUSINESS then VOICEMAIL.MESSAGE=BUSINESS-MESSAGE”. Resolving this rule (in collaborative engine 25) to produce “VOICEMAIL.MESSAGE=BUSINESS-MESSAGE” results in information that must be processed in Bob's network, since Alice's network has no control over Bob's voicemail. One way to implement this would be for collaborative engine 25 to resolve the destination to a virtual phone number belonging to Bob's network, eg “DESTINATION=1234 555555”. When Alice's network routes the call to 12345 on Bob's network, Bob's network uses the results of an IN query to route the call to Bob's voicemail and play the appropriate message.

It will also be readily understood that other forms of telecommunication such as short message service (SMS), email and instant messaging can be routed in a similar fashion and that inference rules for either party may involve a variety of inputs and not only those shown in the example.

The present invention provides a general solution to the problem of resolving inference logic in more than one workspace. Compared to known multi-party inference processing, the present invention significantly reduces the amount of data in each transmission between engines, since partial results need not include resolved goals that are only referred to by other resolved goals, nor goals in the data store that are not referred to during a computation. This is a substantial improvement over known inference logic that must transport all possible goals, including goals that may not be used, to a single inference engine, or perform multiple network transmissions as each new goal is identified that resides in a remote data store.

Since a partial result typically includes only a subset of the goals resolved for a computation, many private goals are not included in a partial result. Private goals that are included in a partial result can be efficiently masked, to avoid disclosing them. In addition, inputs which are not private but which are “location-dependent”, may be processed locally by one of a plurality of interconnected collaborative engines, thereby enabling a result to be produced. Inputs may be location-dependent because they are too big to be transmitted or may be damaged in transit.

Some embodiments of the present invention may not mask private values in the partial result. However, such embodiments retain other benefits of the present invention such as extended negotiation and the reduced transmission overheads between engines.

It will be readily understood that the behaviour of collaborative engines 20 and 25 may be altered by the addition of new goals, such as new rules, or by completely changing one set of goals for another. Consequently, collaborative engines are programmable, and may be deployed to perform one type, or many different types of computations, dependent on the rules and facts associated with them.

Advantageously, collaborative engines 20 and 25 may further protect the contents of partial results passed between them. Since a partial result may contain goals that relate, indirectly, to private data, a malicious party could, in some scenarios, reconstruct private data if sufficient interrelated partial results can be obtained. A malicious party could therefore attempt to cause multiple interrelated partial results to be created for this purpose. A number of prior art techniques can be used to address this possibility including auditing requests, limiting the number of requests within a time period for any party, and authenticating parties using static authentication tokens, such as passwords. Whilst these techniques can all be advantageously used with the present invention, either singly or in combination, preferred embodiments of the invention provide a further technique, in which one party dynamically authenticates itself to another party using a dynamic authentication token, which is a private fact known to both parties. Since the private fact is already known to the receiving party, this does not represent disclosure of that private fact. Each new dynamic authentication preferably uses a new authentication token, based on a different fact, which limits the number of successful authentications to the number of shared private facts, or some function thereof.

In one preferred embodiment, dynamic authentication is implemented between two collaborative engines using a fact from a previous computation collaboratively resolved by both engines. Therefore, the set of facts from which authentication tokens can be generated continually grows as results are generated, but will be exhausted if a significant number of authentications occur without generating a result. Known inference logic is used to identify such a fact from a previous collaborative computation and derive the dynamic authentication token from it. The token is authenticated by comparing it to the private fact. Since this embodiment requires a fact from a previous computation, there will not be an available fact for the first such computation. In this case, the logic may allow the first authentication request from a previously unauthenticated collaborative engine to be an empty token and authenticate it, possibly with limited privilege. Alternatively, initial tokens are provided to each collaborative engine to allow the first dynamic authentication to succeed. Greater security may be obtained by prohibiting facts from one collaborative computation being used to authenticate an immediately following collaborative computation.

Advantageously, conventional authentication techniques may be combined with dynamic authentication for greater security.

Furthermore, a secure transmission protocol may be used to secure the transmission of authentication tokens and partial results. Secure transmission protocols such as SSL and IPSec are known in the art.

An example of dynamic authentication is now described with reference to FIGS. 4 to 6. Considering the same example as previously described with reference to these diagrams, collaborative engine 20 determines (at block 2090 in FIG. 4) a private fact to be used as a dynamic authentication token. In this example, this is fact 3101 (last order=P01234), which collaborative engine 20 determines is a fact associated with a previous transaction with Company-B. Collaborative engine 20 includes this fact as a dynamic authentication token with partial result 45. Collaborative engine 25 dynamically authenticates (at block 2010 in FIG. 4) partial result 45 by confirming that the authentication fact does relate to Company-A, and that it matches the corresponding fact 3601 in dataset 36.

### Further Applications of the Invention

Collaborative devices may be used in a wide variety of applications. In addition to the electronic commerce and communications routing examples described previously, collaborative devices may be deployed and programmed to perform specific tasks, or broad collaboration and negotiation.

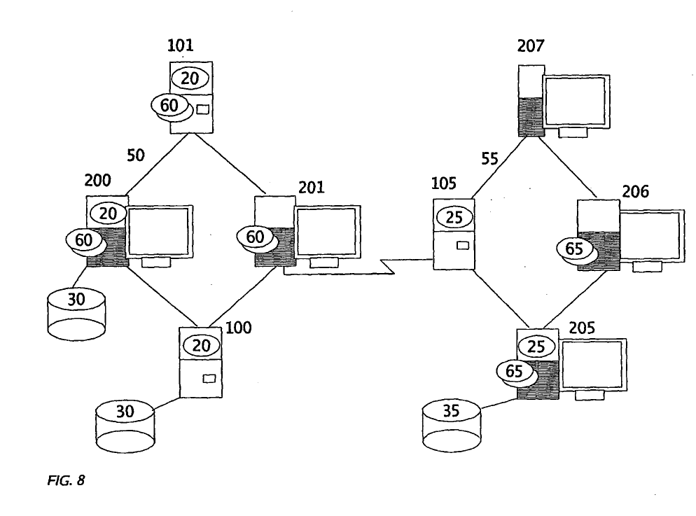

FIG. 8 depicts a distributed data processing system in which multiple computing devices perform multi-party processing as described herein.

As shown in FIG. 8, a distributed data processing system may include a plurality of networks, such as local area networks LAN 50 and LAN 55, each of which may include a plurality of individual computing devices. It will be readily understood that each LAN may be owned by a separate entity, such as a company, and that the LANs may be geographically separated and connected via the Internet or other network.

The individual computing devices may be servers (shared computing devices), such as servers 100, 101 and 105, or clients, such as clients 200, 201, 205, 206 and 207. Individual clients may be workstations, notebook computers, personal computers or the like, having user interface peripherals (eg a keyboard and monitor) which enable a user to initiate processing. Data stores, such as data stores 30 and 35, may be coupled to a server or client and may be utilised to store data, including inference goals.

The computing devices on each LAN owned by an entity may run a plurality of computerised applications for performing a range of collaborative tasks for that entity. Such applications may include workflow, business-to-business, office automation, design, and groupware applications and may run on clients and/or servers. Referring to FIG. 8, collaborative applications 60 run on computing devices on LAN 50 and collaborative applications 65 run on computing devices on LAN 55. Each collaborative application instance may be configured to process collaboratively with one or more corresponding collaborative application instances using one or more collaborative engines 20 and 25.

Servers and/or clients may be collaborative devices running collaborative engines. Servers executing the logic of a collaborative engine are hereafter termed collaborative servers. Collaborative servers 100 and 101 each use a separate collaborative engine 20 and, by adding rules to one or more rulesets in data stores 30, may be programmed to perform specific collaborative tasks. Collaborative server 101 also executes the further logic of some or all of collaborative applications 60. Collaborative server 105 uses a collaborative engine 25 and, by adding rules to one or more rulesets in data store 35, may be programmed to perform specific collaborative tasks.

Clients 200 and 205 are also collaborative devices. Client 200 executes the logic of a collaborative engine 20 and client 205 executes the logic of a collaborative engine 25.

It will be readily understood that collaborative applications and collaborative engines may be loosely coupled (eg collaborative applications use collaborative engines which run on separate computing devices), may be tightly coupled at the logical level (eg a collaborative engine communicates only with a specific collaborative application), or may be tightly coupled at the physical level and run on the same computing device (eg the collaborative engine is embedded in the collaborative application). A distributed data processing system, or a network comprising part of a distributed data processing system, may include any or all forms.

It will further be understood that some applications, such as some workflow and business-to-business applications, may be implemented entirely in goals understandable by a collaborative engine and therefore may be deployed on one or more collaborative servers which do not run collaborative applications. As an example, a company which owns LAN 50, may purchase supplies from a company which owns LAN 55. In response to rules in data store 30, collaborative server 100 may perform collaborative computations with collaborative server 105. Such computations may be automated and may be periodic or in response to events detected by the collaborative servers, such as automated purchasing when stock is low.

Other applications may involve further logic, such as collaborative applications 60 and 65. Collaborative applications 60 and 65 may be office automation applications or more business-specific processing such as design, mechanical modelling, financial modelling etc. Such collaborative applications may contact a collaborative server which performs computations on behalf of the application, or may incorporate a collaborative engine within the application logic to add collaborative abilities to the application.

By way of illustration, with reference to FIG. 8:
One or more clients 200 and/or 201 each execute an instance of a collaborative application 60 to collaborate with one or more collaborative applications 65 running on one or more clients 205 and/or 206 to produce a collaborative result. Collaborative servers 100 and/or 105 and/or the collaborative engines of clients 200 and 205 may be used to compute the collaborative result.
One or more collaborative applications 60 on one or more clients 201, access collaborative server 100 with a request for a collaborative computation. Collaborative server 100 completes the computation in collaboration with one or more collaborative engines 20 or 25, producing the requested result.
A collaborative application 60 on client 200 uses a collaborative engine running on the same client computing device to collaborate with one or more instances of the corresponding application 65 running on one or more clients 205 to complete a collaborative computation.

Collaborative computations may also be requested by a thin client, without execution of a collaborative application. Thin clients may include a web form in a web browser, a Java applet, or a remote command shell (eg telnet or rsh). For example, a user may submit, using client 207, a request for a collaborative computation to collaborative server 105, which may determine the result in collaboration with collaborative server 100 and/or one or more collaborative engines 20.

In another application (not illustrated), a collaborative engine and data store may be incorporated in a network management circuit and be programmed by means of goals in the data store to create a collaborative network management circuit capable of performing error detection, service level management, and network management tasks in collaboration with other collaborative network management circuits. For example, one or more collaborative network management circuits on a major segment of a network could collaborate with one or more collaborative network management circuits on a major segment of another network to reconfigure pathways for traffic in the event of a failure of a component in one of the segments. The circuits could implement automated multi-party rules-based error detection and traffic re-routing including, for example, negotiation of additional bandwidth. The goals could implement business rules reflecting commercial considerations, such as service level agreements (SLAs).

Further areas of application include finance in which, for example, two or more financial institutions may use the present invention to determine a financial computation without disclosing the financial details of the parties involved. Such institutions could include banks, credit providers, and taxation departments, which are typically subject to legal limitations on the information they may disclose.

It will be readily understood that in all cases, data that is private to a domain may be masked and kept private by the relevant collaborative engine or engines. Domain boundaries need not coincide with physical boundaries. For example, there could be multiple domains within a network or data store (eg one for each company department), and/or multiple networks or data stores within a domain (eg multiple LANs or data stores for a company).

### Significant Advantages

The present invention enables a computation to be processed using inference logic without requiring all inputs for that computation to be retrieved into a single inference workspace. This enables private or location-dependent inputs to be used in multi-party computations without being transmitted to other parties and with significantly less network and computational overhead than conventional techniques. Collaborative engines may be embodied in discrete devices, and therefore easily added to existing infrastructure and allowing collaboration and its management to be centrally defined and controlled at the collaborative device level. Additional models for distributing an inference-based computation are also supported, including saving a partial result for later continuation, and generalised parallel processing of complex computations using multiple collaborative devices.

The foregoing describes only some embodiments of the invention, and modifications and additions obvious to those skilled in the art may be utilised without departing from the scope of the present invention.

### GLOSSARY

### Goal

The target of inferencing. Inferencing logic sets the resolution of a goal as its current task, and proceeds. The process of resolving that goal will often lead to uncovering further goals to be resolved. In forward chaining inferencing, these further goals are resolved as a consequence of resolving the first goal. In backward chaining inferencing, these further goals are resolved as a prerequisite to resolving the first goal.
Goals are frequently sub-divided into facts and rules, where a fact is a value for some named entity, and a rule is some relationship, usually in the form “if X then Y”. Backward chaining tends to see only facts as goals, because rules are only ever retrieved to resolve facts. Forward chaining tends to view rules as goals, since resolving one rule may cause further rules to be identified and resolved.
Other forms of inference logic also exist, such as “constraint-based logic” one form of which is uses a type of forward inferencing, wherein the classic rule and fact goals are augmented with constraint goals, which are forward chaining rules which have no “if X” predicate (eg “10<y<100”).
It is useful to note that, effectively, all goals can be expressed as one or more rule goals:
a) (fact): if X has no value then X=100;
b) (constraint): if Y<=10 the assert Y=11; if Y>=100 then assert Y=99

### Unresolvable Goal

A goal that the inferencing logic has determined cannot be resolved. Usually this is because something required to resolve the goal is missing. For example, the inference logic may attempt to follow a reference to a goal X, but discover that it cannot retrieve goal X from any available source. In this situation, goal X is deemed unresolvable. Furthermore, a second goal, goal Y may rely directly on goal X. In this situation, goal Y is also unresolvable, as a consequence of X being unresolvable. A third goal, goal W, may rely indirectly on goal X (for example, by relying directly on goal Y). In this situation if the indirect path from W to X is or becomes the only way to resolve goal W, then goal W also becomes unresolvable.
For example: goal X is a fact goal, eg the discount rate for a purchase (X=?); goal Y is a rule goal, eg a rule that relies on the discount, and goal W is a fact goal which relies on X through the rule goal Y (if X>10% then W=X*1.5).
   Given the above, then if a value cannot be retrieved or otherwise determined for X, then X is unresolvable. The rule goal Y is, as a consequence, unresolvable. If rule Y is the only rule that can resolve W, or if all other remaining rules for W rely on X or other unresolvable goals, then W is, as a consequence, also unresolvable.

### Retrievable Goal

A goal that can be retrieved by a inference logic using a request initiated by the inference logic to a goal source, in contradistinction to a request made, for example, by the inference logic in response to an incoming communication initiated by that source.
A retrievable goal is a goal that can be retrieved into a workspace, on request. So if collaborative engine A can request a goal from a goal source, and receive that requested goal in reply, then that goal is retrievable.

### Partial Result

A set of one or more goals associated with a request for a result which are capable of partially resolving the request but which are insufficient, of themselves, to resolve that request.
At least one of the goals in a partial result is a non-retrievable goal. A non-retrievable goals in a partial result cannot be retrieved from any knowledge base, because it is the result of processing other goals. (A non-retrievable goal in a partial result can also be described as a ‘dynamic’ goal as it is created dynamically from other known goals rather than being retrieved from a static store, or as a ‘transient’ goal as it is a temporary goal which is created as needed, unlike prior art goals that are persist in a knowledge base.)
This means:
c) such non-retrievable goals do not physically exist in any knowledge base. A request by collaborative engine A “send me goal X” cannot result in such a goal, because goal X does not exist in any knowledge base (in fact, because the goal does not exist in any knowledge base, there is no identifier ‘X’ that could be used to retrieve it);
d) such non-retrievable goals cannot be retrieved individually by a single request. Collaborative engine A could send the request “send all goals that resolve X”. The response to this request is a set of multiple goals, not a single goal.
e) such non-retrievable goals can only be calculated in the context of a specific request. If a responding engine did respond to the request “send all goals that resolve X”, the result would not be the same as the set of goals in a corresponding partial result. The partial result would effectively be formed by taking the result of this request, and processing those goals in the context of a specific set of values for a specific request;
f) a request that retrieves the goals of a partial result is therefore not a request for goals, but a request for a result. For example, inference engine A could send the request “send all goals that could resolve X, given A=1, B=2, C=3”. Firstly, this is not a simple request for a goal—it is an exchange of goals. Secondly, what is returned is a result, not a goal. It is the result of processing the provided goals with a request, and generating either a partial or final result, which is the protected action of a sending collaborative engine.

1. A method of electronically processing a request for a result with a collaborative engine using inference logic, the method comprising: generating a partial result as a function of one or more unresolvable goals.

2. A method as claimed in claim 1, wherein insufficient goals are provided to resolve the request.

3. A method as claimed in claim 1, wherein the partial result comprises at least one goal capable of partially resolving the requested result.

4. A method as claimed in claim 1, further comprising retrieving at least one retrievable goal.

5. A method as claimed in claim 1, further comprising identifying unresolvable goals which are capable of partially resolving the request for a result, and wherein the partial result is generated as a function of the identified unresolvable goals.

6. A method as claimed in claim 1, wherein the generating comprises creating a set of unresolvable goals and any goals the unresolvable goals rely on, and including the set in the partial result.

7. A method as claimed in claim 1, wherein the generating comprises creating a subset of a set of unresolvable goals and any goals relied upon by any goal already in the subset, and including the subset in the partial result.

8. A method as claimed in claim 1, wherein the generating comprises masking at least one goal in the partial result.

9. A method as claimed in claim 8, wherein the masking comprises:
(i) modifying the goal, or one or more goals that refer to the goal, and/or
(ii) replacing the goal, or a value in the goal, with a generated goal or value that is known only to a collaborative engine performing the masking, or other processes in the same security domain as that engine.

10. A method as claimed in claim 1, wherein the collaborative engine comprises a sending collaborative engine, the method further comprising;
(i) including the partial result with a further request for a result and transmitting that further request to at least one further collaborative engine or an executing piece of logic; or
(ii) storing the partial result.

11. A method as claimed in claim 10, wherein the transmitting a is preceded by generating a dynamic authentication token from one or more retrievable goals and including the dynamic authentication token with the further request for a result to be transmitted to the at least one further collaborative engine.

12. A method as claimed in claim 1, wherein the generated dynamic authentication token has not been transmitted previously as a dynamic authentication token to said at least one further collaborative engine.

13. A method of electronically processing a request for a result with a collaborative engine using inference logic, wherein the collaborative engine comprises a receiving collaborative engine, and wherein the request for a result includes at least one goal which is capable of partially resolving the request for a result and which is not a retrievable goal, the method compising: processing the request for a result as a function of retrievable goals and the at least one goal included in the request for a result.

14. A method as claimed in claim 13, wherein the request for a result further comprises a dynamic authentication token, the method further comprising validating the included authentication token and proceeding if the validating succeeds, and otherwise terminating the processing if the validating fails.

15. A method as claimed in claim 13, wherein the collaborative engine comprises a transceiving collaborative engine, the method further comprising:
(i) if the request for a result includes at least one goal capable of partially resolving the requested result, processing the request for a result as a function of retrievable goals and the at least one goal included in the request for a result, or
(ii) otherwise, processing the request for a result as a function of retrievable goals.

16. A method as claimed in claim 1, wherein
(i) the request for a result is processed with two or more collaborative engines,
(ii) if insufficient goals are provided within retrievable goals and, if applicable, the at least one goal included in the request for a result, to resolve the requested result, a partial result is generated, and
(iii) if a partial result is generated, a further request for a result which includes the partial result is transmitted to at least one further collaborative engine.

17. A method as claimed in claim 1, wherein the inference logic comprises rules-based logic.

18. A method as claimed in claim 1, wherein the request for a result is a request for a routing path for electronic communication to or from a user of a communication network.

19. A method as claimed in claim 18, further comprising retrieving at least one retrievable goal which is a fact or rule relating to the processing of electronic communications for that user.

20. A method as claimed in claim 18, wherein the request for a result is a request for a routing path for a telephonic connection.

21. A method as claimed in claim 20, further comprising retrieving at least one goal which is a fact or rule relating to the determining of a routing path for a telephonic connection for that user.

22. A method as claimed in claim 18, wherein the request for a result is a request for a routing path for a communication message from or to a user of that network.

23. A method as claimed in claim 22, further comprising retrieving at least one goal which is a fact or rule relating to the determining of a routing path for a communication message for that user.

24. A method as claimed in of claim 1, wherein the request for a result is a request for a management action for a component of an electronic data network.

25. A method as claimed in claim 24, further comprising retrieving at least one retrievable goal which is a fact or rule relating to the management of that component.

26. A method as claimed in claim 1, wherein the request for a result is a request for a commercial transaction.

27. A method as claimed in claim 26, further comprising retrieving at least one retrievable goal which is a fact or rule relating to the processing of a commercial transaction.

28. A method as claimed in claim 1, wherein the request for a result is a request to perform office-automation, workflow, calendar, or document management processing.

29. A method as claimed in claim 28, further comprising retrieving at least one retrievable goal which is a fact or rule relating to office-automation, workflow, calendar, or document management processing.

30. A collaborative engine for electronically processing a request for a result using inference logic, wherein the collaborative engine is configured to generating a partial result as a function of one or more unresolvable goals.

31. A collaborative engine as claimed in claim 30, wherein the request for a result comprises a partial result, the collaborative engine further including means for processing the partial result.

32. A collaborative engine as claimed in claim 30, wherein the collaborative engine is adapted to produce a partial result in the event that insufficient goals are available to resolve the request.

33. A collaborative engine for electronically processing a request for a result using inference logic, wherein the request for a result comprises a partial result, and wherein the collaborative engine is configured to process the partial result.

34. A collaborative engine as claimed in claim 30, wherein the collaborative engine is connected to at least one communication network and is adapted to process a request for a routing path for electronic communication to or from a user of the communication network.

35. A collaborative engine as claimed in claim 34, wherein the collaborative engine is adapted to retrieve at least one retrievable goal which is a fact or rule relating to the processing of electronic communications for that user.

36. A collaborative engine as claimed in claim 30, wherein the collaborative engine is connected to at least one electronic data network and is adapted to process a request to determine a management action regarding at least one component of that network.

37. A collaborative engine as claimed in claim 36, wherein the collaborative engine is adapted to retrieve at least one retrievable goal which is a fact or rule relating to the management of at least one component of that network.

38. A collaborative engine as claimed in claim 30, wherein the collaborative engine is connected to at least one electronic data network and is adapted to process a request to determine a commercial transaction for a user connected to that network.

39. A collaborative engine as claimed in claim 38, wherein the collaborative engine is adapted to retrieve at least one retrievable goal which is a fact or rule relating to the processing of a commercial transaction for that user.

40. A collaborative engine as claimed in claim 30, wherein the collaborative engine is connected to at least one electronic data network and is adapted to process a request to perform office-automation, workflow, calendar, or document management processing for a user connected to that network.

41. A collaborative engine as claimed in claim 40, wherein the collaborative engine is adapted to retrieve at least one retrievable goal which is a fact or rule relating to office-automation, workflow, calendar, or document management processing for that user.

42. A collaborative engine as claimed in claim 30, wherein the inference logic uses rules-based logic.

43. A method of electronically processing a request for a result with a collaborative engine using inference logic, the method comprising: processing a partial result as a function of one or more retrievable goals.

44. A collaborative engine for electronically processing a request for a result using inference logic, comprising:
means for generating a partial result as a function of one or more unresolvable goals; and
means for identifying unresolvable goals which are capable of partially resolving the request for a result, wherein the partial result is generated as a function of the identified unresolvable goals.
